(19) United States
(12) Patent Application Publication
(10) Pub. No.: US 2025/0272695 A1
(43) Pub. Date: Aug. 28, 2025

(54) GREENHOUSE GAS EMISSIONS MODEL GENERATING SYSTEM

(71) Applicant: The Toronto-Dominion Bank, Toronto (CA)

(72) Inventors: Saeed KADDOURA, Toronto (CA); Arjang TAJBAKHSH, Montreal (CA); Mark LOFTIN, Easley, SC (US); Willian Teixeira Silva DE SOUSA, Toronto (CA)

(21) Appl. No.: 18/590,338

(22) Filed: Feb. 28, 2024

(51) Int. Cl. G06Q 30/018

(52) U.S. Cl. CPC G06Q 30/018

(57) ABSTRACT

An emissions model generating system includes an identifier decoder, an emissions database, and an emissions modeller. The identifier decoder receives indefinite article identifiers and translates the indefinite article identifiers into attribute sets. Each indefinite article identifier non-uniquely identifies an article of manufacture. Each attribute set includes article attributes associated with the respective article of manufacture. The emissions database comprises records each including greenhouse gas emissions data indexed by the article attributes. The emissions modeller receives the attribute sets and translates each received attribute sets into an emissions model by locating a respective matching emissions record in the emissions database. Amongst the plurality of emissions records, the article attributes of the received attribute set most closely match the article attributes of the respective matching emissions record.

### FIELD

This patent application relates to a system and method for generating greenhouse gas emissions models.

### BACKGROUND

Greenhouse gas (GHG) emissions are considered a significant contributing factor to climate change. In attempt to reverse or slow the rate of climate change, businesses may be encouraged to reduce or at least monitor the GHG emissions that are directly or indirectly involved in the operation of the business. Therefore, it may be advantageous for a business that operates, sells, leases or otherwise transacts business using articles of manufacture that emit greenhouse gases to be able to estimate the GHG emissions of those articles. However, privacy legislation may restrict the information that the business can release to a third party service for estimating those GHG emissions.

### SUMMARY

This patent application describes a greenhouse gas emissions model generating system and an associated method that uses indefinite article identifiers of articles of manufacture to generate greenhouse gas emissions models of the greenhouse gas emissions of those articles of manufacture.

A first aspect of this disclosure relates to a greenhouse gas emissions model generating (GHG-EMG) system that includes an identifier decoder, an emissions database, and an emissions modeller.

The identifier decoder is configured to receive indefinite article identifiers and to translate the received indefinite article identifiers into attribute sets. Each indefinite article identifier non-uniquely identifies an article of manufacture. Each attribute set includes article attributes that are associated with the respective article of manufacture.

The emissions database includes a plurality of emissions records. Each emissions record of the emissions database includes greenhouse gas emissions data indexed by the article attributes.

The emissions modeller is configured to receive the attribute sets and to translate each received attribute set into a greenhouse gas emissions model. The emissions modeller translates each received attribute set by locating a respective matching emissions record in the emissions database. Amongst the plurality of emissions records, the article attributes of each received attribute set most closely match the article attributes of the respective matching emissions record.

A second aspect of this disclosure relates to a method of generating greenhouse gas emissions models.

The method involves an identifier decoder receiving indefinite article identifiers and translating the received indefinite article identifiers into attribute sets. Each indefinite article identifier non-uniquely identifies an article of manufacture. Each attribute set includes article attributes that are associated with the respective article of manufacture.

The method further involves an emissions modeller receiving the attribute sets, and translating each received attribute set into a greenhouse gas emissions model via an emissions database. The emissions database includes a plurality of emissions records. Each emissions record of the emissions database includes greenhouse gas emissions data indexed by the article attributes.

The emissions modeller translates each received attribute set by locating a respective matching emissions record in the emissions database. Amongst the plurality of emissions records, the article attributes of each received attribute set most closely match the article attributes of the respective matching emissions record.

A third aspect of this disclosure relates to a non-transient computer-readable medium that carries processing instructions which, when executed by a computer, cause the computer to receive indefinite article identifiers, and to translate the received indefinite article identifiers into attribute sets. Each indefinite article identifier non-uniquely identifies an article of manufacture. Each attribute set includes article attributes that are associated with the respective article of manufacture.

The processing instructions, when executed by the computer, further cause the computer to translate each attribute set into a greenhouse gas emissions model via an emissions database. The emissions database includes a plurality of emissions records. Each emissions record of the emissions database includes greenhouse gas emissions data indexed by the article attributes.

The computer translates each attribute set by locating a respective matching emissions record in the emissions database. Amongst the plurality of emissions records, the article attributes of each attribute set most closely match the article attributes of the respective matching emissions record.

Each indefinite article identifier may identify a group of articles that includes the respective article of manufacture. Each attribute set may include the article attributes that are common to the respective group of articles.

In one implementation, each article of manufacture is uniquely identified by a respective unique sequence of characters, and each indefinite article identifier includes a sub-set of the respective unique sequence of characters. The sub-set includes fewer of the characters than the respective unique sequence of characters.

In one implementation, the identifier decoder retrieves the indefinite article identifiers from an asset database each via one of a plurality of threads and translates the received indefinite article identifiers by at least saving the attribute sets in the attribute database each via the respective thread. The asset database includes a plurality of asset records. Each asset record of the asset database may be associated with one of the articles of manufacture, and may include the indefinite article identifier of the article of manufacture. The attribute database may include a plurality of attribute records. Each attribute record of the attribute database may be associated with one of the articles of manufacture, and may include the attribute set of the article of manufacture.

Since each indefinite article identifier non-uniquely identifies a respective article of manufacture, the GHG-EMG system and the associated method can generate greenhouse gas emissions models without violating privacy legislation that might restrict the information that may be made available to a business attempting to model greenhouse gas emissions.

Moreover, since the identifier decoder may retrieve the indefinite article identifiers and may save the attribute sets via a plurality of threads, the GHG-EMG system and the associated method may reduce the time required to generate greenhouse gas emissions models in comparison to the state of the art. Since the GHG-EMG system may, therefore, generate greenhouse gas emissions models at a faster rate than state of the art solutions, the GHG-EMG system may also constitute an improved computing system.

### BRIEF DESCRIPTION OF THE DRAWINGS

An exemplary greenhouse gas emissions model generating (GHG-EMG) system and method of generating greenhouse gas emissions models will now be described, with reference to the accompanying drawings, in which:

FIG. 1 is a schematic view of the GHG-EMG system, depicting a greenhouse gas (GHG) emissions modelling platform, an asset database, and a greenhouse gas (GHG) emissions database;

FIG. 2 is a schematic view of GHG emissions modelling platform;

FIG. 3 is a flowchart that depicts the method of method of generating greenhouse gas emissions models;

FIG. 4 is a sample greenhouse gas emissions model, depicting a distribution of greenhouse gas emissions emitted per unit of fuel consumed for articles of manufacture; and

FIG. 5 is another sample greenhouse gas emissions model, depicting a distribution of greenhouse gas emissions emitted per unit of loan amount for articles of manufacture.

### DETAILS

### 1. Greenhouse Gas Emissions Model Generating (GHG-EMG) System-Overview

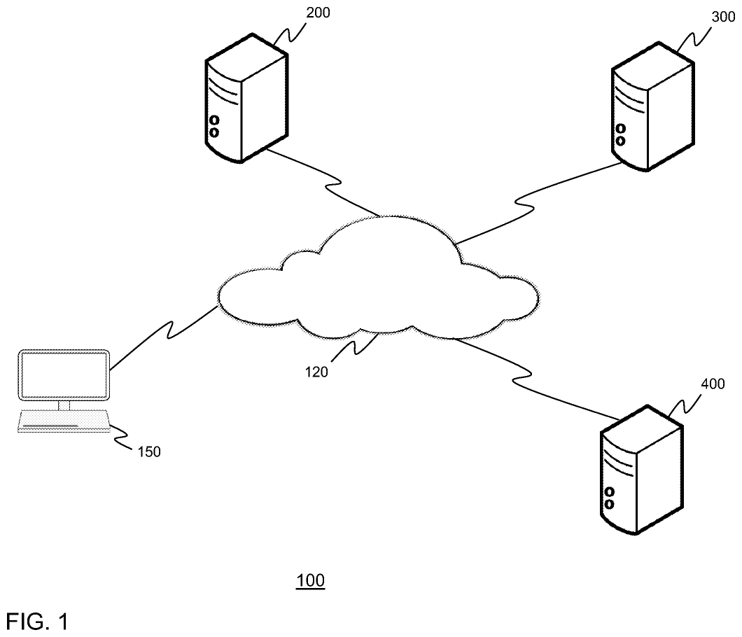

FIG. 1 is a schematic view of the greenhouse gas emissions model generating (GHG-EMG) system, denoted generally as 100. As shown, the GHG-EMG system 100 includes an operator terminal 150, a greenhouse gas (GHG) emissions modelling platform 200, an asset database 300 and a greenhouse gas (GHG) emissions database 400.

The operator terminal 150 is implemented as a computer terminal, and includes an input device, a display device, a network interface and a computer processing subsystem that is coupled to the input device, the display device and the network interface. The computer processing subsystem accepts operator input from the input device, outputs information on the display device, and communicates with the network interface. The network interface allows the operator terminal 150 to communicate with the GHG emissions modelling platform 200 via a computer network 120.

The GHG emissions modelling platform 200 is in communication with the operator terminal 150, the asset database 300 and the GHG emissions database 400 via the computer network 120. The GHG emissions modelling platform 200 is configured to receive indefinite article identifiers, translate the received indefinite article identifiers into attribute sets, and translate the attribute sets into greenhouse gas emissions models, and provide the operator terminal 150 with the greenhouse gas emissions models.

Each indefinite article identifier non-uniquely identifies an article of manufacture. Therefore, each indefinite article identifier may identify a group of articles that includes the respective article of manufacture. Each attribute set includes one or more article attributes that are associated with the respective article of manufacture. Therefore, each attribute set includes the article attribute(s) common to the respective article(s).

The asset database 300 is deployed on a database server and includes a plurality of asset records. Each asset record of the asset database 300 is associated with an article of manufacture and includes the indefinite article identifier of the respective article of manufacture. Since each indefinite article identifier non-uniquely identifies an article of manufacture, the same indefinite article identifier may appear in more than one asset record of the asset database 300. Alternately, in order to increase the speed at which the GHG emissions modelling platform 200 can generate the greenhouse gas emissions models, the asset records of the asset database 300 may be pre-processed to ensure that no indefinite article identifier appears in more than one asset record of the asset database 300.

The GHG emissions database 400 is deployed on a database server and includes a plurality of emissions records. Each emissions record of the GHG emissions database 400 is associated with one or more articles of manufacture and includes greenhouse gas emissions data indexed by the article attribute(s) of the associated article(s) of manufacture. As will be explained, the GHG emissions modelling platform 200 generates the greenhouse gas emissions models from the attribute sets and from the greenhouse gas emissions data stored in the GHG emissions database 400.

In one implementation, each indefinite article identifier non-uniquely identifies a respective motor vehicle. The GHG emissions modelling platform 200 may translate the attribute sets into the greenhouse gas emissions models by generating emissions intensity values from the greenhouse gas emissions data associated with the attribute sets in the GHG emissions database 400 and incorporating the emissions intensity values into the greenhouse gas emissions models. Each emissions intensity value may identify a volume and/or mass of greenhouse gas emitted per unit of distance travelled for the respective group of motor vehicles.

The entity that operates the GHG-EMG system 100 might be tasked with generating greenhouse emissions models for a financial institution that finances the purchase of articles of manufacture. In this latter implementation, the asset database 300 may be maintained by the financial institution, and each asset record of the asset database 300 may include a monetary amount for the respective article of manufacture financed by the financial institution (in addition to the indefinite article identifier of the respective article of manufacture). The GHG emissions modelling platform 200 may translate the attribute sets into the greenhouse gas emissions models by generating asset intensity values from the greenhouse gas emissions data and the monetary amounts and incorporating the asset intensity values into the greenhouse gas emissions models. Each asset intensity value may identify a volume and/or mass of greenhouse gas emitted per unit of the monetary amount.

Although the operator terminal 150, GHG emissions modelling platform 200, asset database 300 and GHG emissions database 400 are depicted in FIG. 1 as being separate and distinct components of the GHG-EMG system 100, the functionality of the operator terminal 150, asset database 300 and/or GHG emissions database 400 may be incorporated into the GHG emissions modelling platform 200. Similarly, although the asset database 300 and GHG emissions database 400 are depicted in FIG. 1 as being deployed on separate and distinct database servers, the asset database 300 and GHG emissions database 400 may be deployed instead on a common database server.

### 2. GHG Emissions Modelling Platform

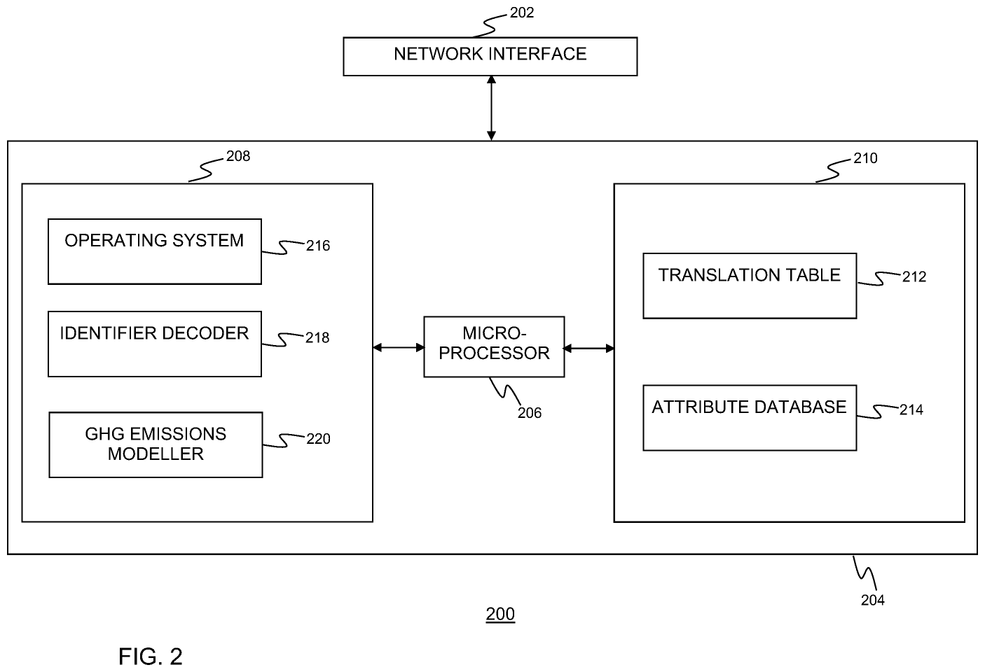

As shown in FIG. 2, the GHG emissions modelling platform 200 may be implemented as a computer server, and includes a network interface 202 and a computer processing subsystem 204 that is coupled to the network interface 202.

The network interface 202 interfaces the GHG emissions modelling platform 200 with the operator terminal 150, the asset database 300 and the GHG emissions database 400 via the network 120.

The computer processing subsystem 204 includes one or more microprocessors 206, a volatile computer-readable memory 208, and a non-transient non-volatile computer-readable memory 210. The non-volatile computer-readable memory 210 may be provided as one or more of a magnetic storage drive and a solid-state drive and may store a translation table 212 and an attribute database 214. Alternately, the translation table 212 and/or the attribute database 214 may be deployed on database servers (not shown) that are distinct from and accessible by the GHG emissions modelling platform 200 via the network 120.

The translation table 212 includes a plurality of translation records. Each translation record of the translation table 212 is associated with an article of manufacture and stores an indefinite article identifier that non-uniquely identifies the respective article of manufacture. Each translation record of the translation table 212 also stores an attribute set of one or more article attributes that are associated with the respective article of manufacture.

As discussed, each indefinite article identifier may identify a group of related articles of manufacture that includes the respective article of manufacture. Therefore, in the translation table 212, each indefinite article identifier identifies articles of manufacture that have a common set of article attributes, and the attribute set stored in each translation record identifies the article attribute(s) common to the respective group of articles.

The attribute database 214 includes a plurality of attribute records. Each attribute record of the attribute database 214 is associated with an article of manufacture, and stores the attribute set for the associated article of manufacture. As discussed, the GHG emissions modelling platform 200 generates the attribute sets from the indefinite article identifiers stored in the asset database 300. Since each indefinite article identifier non-uniquely identifies an article of manufacture, the same attribute set may appear in more than one attribute record of the attribute database 214.

As discussed above, the entity that operates the GHG-EMG system 100 might be tasked with generating greenhouse emissions models for a financial institution that finances the purchase of articles of manufacture. In this latter implementation, each attribute record of the attribute database 214 may also include the monetary amount for the respective article of manufacture financed by the financial institution.

The non-volatile computer-readable memory 210 also stores computer processing instructions which, when copied into the volatile computer-readable memory 208, and executed by the microprocessor(s) 206, implement an operating system 216, an identifier decoder 218, and a greenhouse gas (GHG) emissions modeller 220.

The operating system 216 allows the GHG emissions modelling platform 200 to communicate with the operator terminal 150, the asset database 300 and the GHG emissions database 400, and controls the invocation of the identifier decoder 218 and the GHG emissions modeller 220.

The identifier decoder 218 is configured to receive indefinite article identifiers and to translate the received indefinite article identifiers into attribute sets. Each attribute set includes the article attributes that are associated with the respective article of manufacture. The identifier decoder 218 may retrieve the indefinite article identifiers (together with the associated monetary amounts, if applicable) from the asset database 300, and may translate each retrieved indefinite article identifier by (i) querying the translation table 212 with each retrieved indefinite article identifier, to thereby locate the attribute set associated with the respective article of manufacture in the translation table 212, and (ii) saving each located attribute set (together with the associated monetary amount, if applicable) in the attribute database 214.

The GHG emissions modeller 220 is configured to receive the attribute sets provided by the identifier decoder 218, and to translate each received attribute sets into a greenhouse gas emissions model. The GHG emissions modeller 220 may translate each received attribute set into a greenhouse gas emissions model by (i) locating a respective matching emissions record in the emissions database 400, and (ii) incorporating the greenhouse gas emissions data from the matching emissions record into the greenhouse gas emissions model. Amongst all of the emissions records in the emissions database 400, the article attributes of each received attribute set most closely match the article attributes of the respective matching emissions record.

As discussed above, in one implementation, each attribute record of the attribute database 214 may also include a monetary amount for the respective article of manufacture. In this latter implementation, the GHG emissions modeller 220 may translate the attribute sets into greenhouse gas emissions models by generating asset intensity values from the located greenhouse gas emissions data and the associated monetary amounts, and incorporating the generated asset intensity values into the greenhouse gas emissions models.

The GHG emissions modeller 220 may be configured to locate each matching emissions record by querying the GHG emissions database 400 with each received attribute set to thereby locate the emissions record having article attributes that fully match the received attribute set. The foregoing solution will be effective where the attribute set generated by the identifier decoder 218 (i.e. the attribute set returned by the query of the translation table 212) matches one of the attribute sets stored in the GHG emissions database 400. However, if the GHG emissions modelling platform 200 and the GHG emissions database 400 are maintained by different entities, the translation table 212 might include an attribute set that is not included in the GHG emissions database 400. In that situation, the query of the GHG emissions database 400, by the GHG emissions modeller 220, might not locate an emissions record having an attribute set that fully matches the attribute set that was provided by the identifier decoder 218.

Accordingly, if the query of the GHG emissions database 400 does not locate an emissions record fully matching the attribute set provided by the identifier decoder 218, the GHG emissions modeller 220 may be configured to then use a fuzzy name matching algorithm to locate the greenhouse gas emissions data most closely associated with the attribute set (generated by the identifier decoder 218) in the GHG emissions database 400.

Alternately, instead of locating each matching emissions record by first performing a database query of the GHG emissions database 400 and then applying the fuzzy name matching algorithm to the GHG emissions database 400 if the query of the GHG emissions database 400 does not locate an emissions record fully matching the attribute set provided by the identifier decoder 218, the GHG emissions modeller 220 may be configured to locate each matching emissions record by applying a fuzzy name matching algorithm to the GHG emissions database 400 (i.e. without first performing a database query of the GHG emissions database 400).

In a preferred implementation, the microprocessor(s) 206 is/are capable of implementing a plurality of threads, and the identifier decoder 218 is configured to (a) retrieve the indefinite article identifiers (together with the associated monetary amounts, if applicable) from the asset database 300 each via a respective one of the threads, and (b) translate each retrieved indefinite article identifier by (i) querying the translation table 212 with each retrieved indefinite article identifier via the respective thread, to thereby locate the attribute set associated with the respective article of manufacture in the translation table 212, and (ii) saving each located attribute set in the attribute database 214 (together with the associated monetary amount, if applicable) via the respective thread.

The plurality of threads allows the identifier decoder 218 to concurrently translate multiple indefinite article identifiers into article attributes. Therefore, the GHG emissions modelling platform 200 can translate indefinite article identifiers at a faster rate than if the identifier decoder 218 was configured to translate an indefinite article identifier only after generating and saving the attribute set for the previous indefinite article identifier. Since the plurality of threads, therefore, also allows the GHG emissions modeller 220 to generate greenhouse gas emissions models faster than state of the art solutions, the foregoing implementation of the GHG-EMG system 100 constitutes an improved computing system.

As discussed above, the identifier decoder 218 and the GHG emissions modeller 220 may be implemented on a common computing platform (GHG emissions modelling platform 200) via a single computer processing subsystem 204. However, the GHG-EMG system 100 is not restricted to that implementation. For example, the identifier decoder 218 and the GHG emissions modeller 220 may be implemented instead on separate computing platforms via distinct computer processing subsystems. Further, although the identifier decoder 218 and the GHG emissions modeller 220 may be implemented as computer processing instructions on a computing platform, all or a portion of the functionality performed by the identifier decoder 218 and/or the GHG emissions modeller 220 may be implemented instead in electronics hardware, such as a field programmable logic gate array (FPGA) or a complex programmable logic device (CPLD).

### 3. Method of Generating Greenhouse Gas Emissions Models

As discussed above, the GHG-EMG system 100 includes an identifier decoder 218 and a GHG emissions modeller 220 which together implement a method of generating GHG emissions models.

As will be explained, in accordance with the foregoing method, the identifier decoder 218 receives indefinite article identifiers each non-uniquely identifying an article of manufacture, and translates the received indefinite article identifiers into attribute sets that each include one or more article attributes associated with the respective article of manufacture. The GHG emissions modeller 220 receives the attribute sets and translates each received attribute set into a GHG emissions model.

The GHG emissions modeller 220 may translate each received attribute set into a greenhouse gas emissions model by (i) locating a respective matching emissions record in the emissions database 400, and (ii) incorporating the greenhouse gas emissions data from the matching emissions record into the greenhouse gas emissions model. Amongst all of the emissions records in the emissions database 400, the article attributes of each received attribute set most closely match the article attributes of the respective matching emissions record.

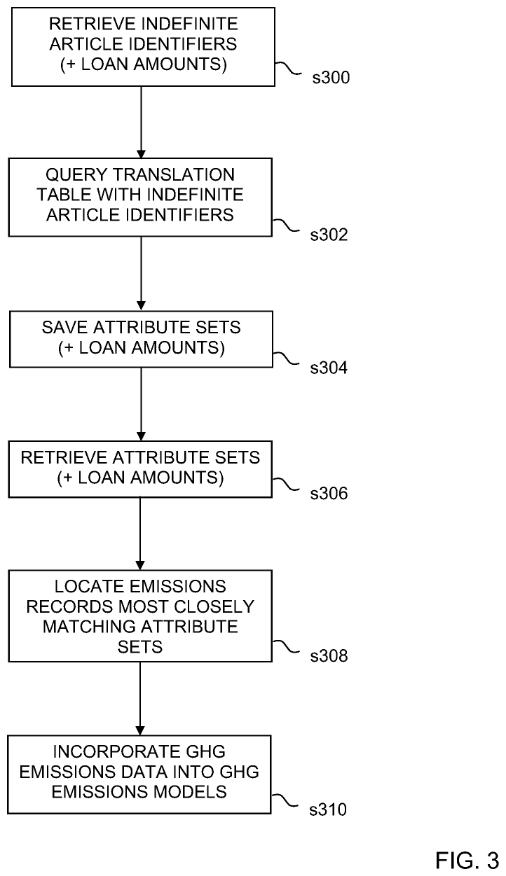

An exemplary method of generating GHG emissions models will now be discussed in detail with reference to FIG. 3.

In the following example, the articles of manufacture are motor vehicles, and the entity that operates the GHG-EMG system 100 is tasked with generating greenhouse emissions models for a financial institution that provides loans for the purchase of motor vehicles. Therefore, each asset record of the asset database 300 includes both the indefinite article identifier of the respective motor vehicle and the loan amount for the motor vehicle.

Motor vehicles are typically each uniquely identified by a 17-character vehicle identification number (“VIN”). In North America, the VIN may encode the following information:

| Character Position | Encoded Information |
|---|---|
| 1-3 | world manufacturer identifier |
| 4-8 | vehicle descriptor (e.g. vehicle type, |
| | platform, model, body style) |
| 9 | check digit |
| 10 | model year |
| 11 | plant code |
| 12-17 | unique serial or production number |

In order to ensure that the entity that operates the GHG-EMG system 100 complies with privacy legislation that may restrict the information that may be legally made available to that entity, in the following example the indefinite article identifiers used by the GHG-EMG system 100 do not include all 17 characters of the VIN of the motor vehicles financed by the financial institution. Instead, in the following example, the indefinite article identifiers stored in each asset record of the asset database 300 (and in each translation record of the translation table 212) includes a sub-set (consisting of less than 17 characters) of the VIN of the motor vehicle.

In one implementation, the indefinite article identifier stored in each asset record of the asset database 300 consists of only (i) the first eight (8) characters of the VIN of the motor vehicle, and (ii) the model year of the motor vehicle. Alternatively, since the ninth character of the vehicle identification number is a check digit that facilitates validation of the VIN, in another implementation the indefinite article identifiers stored in each asset record of the asset database 300 consists of only the first nine (9) characters of the VIN.

In the following example, the attribute sets stored in the translation table 212 (and in the GHG emissions database 400) identify one or more of the estimated fuel consumption, fuel type, engine displacement, body style, transmission type (e.g. manual, automatic, continuously-variable), and drive type (e.g., two-wheel drive, four-wheel drive, all-wheel drive) of the associated motor vehicle(s). The entity that operates the GHG-EMG system 100 may create the translation table 212 from data available from a suitable public authority, such as the U.S. National Highway Traffic Safety Administration. Alternately, the entity that operates the GHG-EMG system 100 may create the translation table 212 from other sources, such as motor vehicle manufacturers.

Further, in the following example, the greenhouse gas emissions data stored in the GHG emissions database 400 identify one or more of the volume and/or mass of the carbon dioxide, methane, nitrous oxide, fluorocarbons, sulfur dioxide, and/or volatile organic compounds produced per unit volume of fuel consumed by the associated motor vehicle(s). The GHG emissions database 400 may be provided by a suitable public authority, such as the U.S. Environmental Protection Agency. Alternately, the entity that operates the GHG-EMG system 100 may create the GHG emissions database 400 from other sources, such as motor vehicle manufacturers.

The method commences when the operator of the operator terminal 150 uses the operator terminal 150 to issue a command to the GHG emissions modelling platform 200, commanding the GHG emissions modelling platform 200 to generate attribute sets from the indefinite article identifiers stored in the asset database 300. As discussed above, in order to increase the speed at which the GHG emissions modelling platform 200 can generate the greenhouse gas emissions models, the asset records of the asset database 300 may have been pre-processed to ensure that no indefinite article identifier appears in more than one asset record of the asset database 300 (i.e. to ensure that each indefinite article identifier is unique within the asset database 300).

In response to the foregoing command issued by the operator of the operator terminal 150, the identifier decoder 218 retrieves the indefinite article identifiers and the associated loan amounts, for the respective motor vehicles, from the asset records of the asset database 300, at step S300.

After the identifier decoder 218 retrieves the indefinite article identifiers (and the loan amounts) from the asset database 300, the identifier decoder 218 translates the retrieved indefinite article identifiers into article attributes of the associated motor vehicles. The identifier decoder 218 may initiate the translation step, at step S302, by querying the translation table 212 with each retrieved indefinite article identifier to thereby locate the translation record that stores the indefinite article identifier that matches the retrieved indefinite article identifier.

If the identifier decoder 218 is unable to locate a matching translation record (i.e. unable to locate the attribute set that is associated with the motor vehicle in the translation table 212), the identifier decoder 218 may complete the translation step, at step S304, by saving, in the attribute database 214, an attribute record that includes the loan amount and a default attribute set. The default attribute set may include article attributes for a generic motor vehicle. However, if the identifier decoder 218 locates the matching translation record, the identifier decoder 218 may complete the translation step, at step S304, by saving, in the attribute database 214, an attribute record that includes the loan amount and the located attribute set.

The microprocessor(s) 206 may be capable of implementing a plurality of threads. Therefore, the identifier decoder 218 may retrieve the indefinite article identifiers and the associated loan amounts from the asset database 300 each via a respective one of the threads, query the translation table 212 with each retrieved indefinite article identifier via the respective thread, and save each located attribute set and the associated loan amount in the attribute database 214 via the respective thread.

As discussed above, in this example, the attribute sets stored in the translation table 212 (and in the GHG emissions database 400) identify one or more of the estimated fuel consumption, fuel type, engine displacement, body style, transmission type (e.g. manual, automatic, continuously-variable), and drive type (e.g., two-wheel drive, four-wheel drive, all-wheel drive) of the associated motor vehicle(s). Therefore, in this example, after the identifier decoder 218 has translated the indefinite article identifiers (retrieved from the asset database 300), each record of the attribute database 214 will include, for the associated motor vehicle, one or more of the foregoing article attributes and the associated loan amount.

After the identifier decoder 218 has populated the attribute database 214 with the attribute sets and the associated loan amounts, as discussed above, the GHG emissions modeller 220 retrieves the attribute sets and the associated loan amounts from the attribute database 214, at step S306. The GHG emissions modeller 220 then translates each retrieved attribute set into a greenhouse gas emissions model.

The GHG emissions modeller 220 translates each retrieved attribute set by (i) locating a respective matching emissions record in the emissions database 400, at step S308, and (ii) incorporating the greenhouse gas emissions data from the located matching emissions record into the greenhouse gas emissions model, at step S310. Amongst all of the emissions records stored in the emissions database 400, the article attributes of each received attribute set most closely match the article attributes of the respective matching emissions record.

The GHG emissions modeller 220 may locate each matching emissions record by querying the emissions database 400 with each received attribute set to thereby locate the emissions record having article attributes that fully match the received attribute set. However, as discussed above, the foregoing solution will be effective where the attribute set generated by the identifier decoder 218 matches one of the attribute sets stored in the GHG emissions database 400. Therefore, if the query of the GHG emissions database 400 does not locate an emissions record fully matching the attribute set provided by the identifier decoder 218, the GHG emissions modeller 220 may use a fuzzy name matching algorithm to locate the greenhouse gas emissions data most closely associated with the attribute set (generated by the identifier decoder 218) in the GHG emissions database 400.

The fuzzy name matching algorithm may cause the GHG emissions modeller 220 to locate the most closely associated greenhouse gas emissions data by, for example:
(i) generating a plurality of vectors each from a string of the article attributes of the article set stored in the respective emissions record of the GHG emissions database 400 (“reference vectors”),
(ii) generating a vector from a string of the article attributes of the article set provided by the identifier decoder 218 (“sample vector”),
(iii) computing the Levenshtein distance or the cosine of similarity between the sample vector and each of the reference vectors, and
(iv) selecting the greenhouse gas emissions data from the emissions record having the smallest Levenshtein distance or the largest cosine of similarity.

Alternately, instead of locating each matching emissions record by first performing a database query of the GHG emissions database 400 and then applying the fuzzy name matching algorithm to the GHG emissions database 400 if the query of the GHG emissions database 400 does not locate an emissions record fully matching the attribute set provided by the identifier decoder 218, the GHG emissions modeller 220 may locate each matching emissions record, at step S308, by applying a fuzzy name matching algorithm to the GHG emissions database 400 (i.e. without first performing a database query of the GHG emissions database 400).

The GHG emissions modeller 220 may incorporate the greenhouse gas emissions data from the matching emissions records, into the greenhouse gas emissions models, by generating emissions intensity values from the located greenhouse gas emissions data and incorporating the generated emissions intensity values into the greenhouse gas emissions models. The GHG emissions modeller 220 may then transmit the greenhouse gas emissions models to the operator terminal 150 for rendering on the display device thereof. Each emissions intensity value incorporated into the greenhouse gas emissions models may identify the volume and/or mass of greenhouse gases emitted per unit of distance travelled for the motor vehicles having the associated set of article attributes.

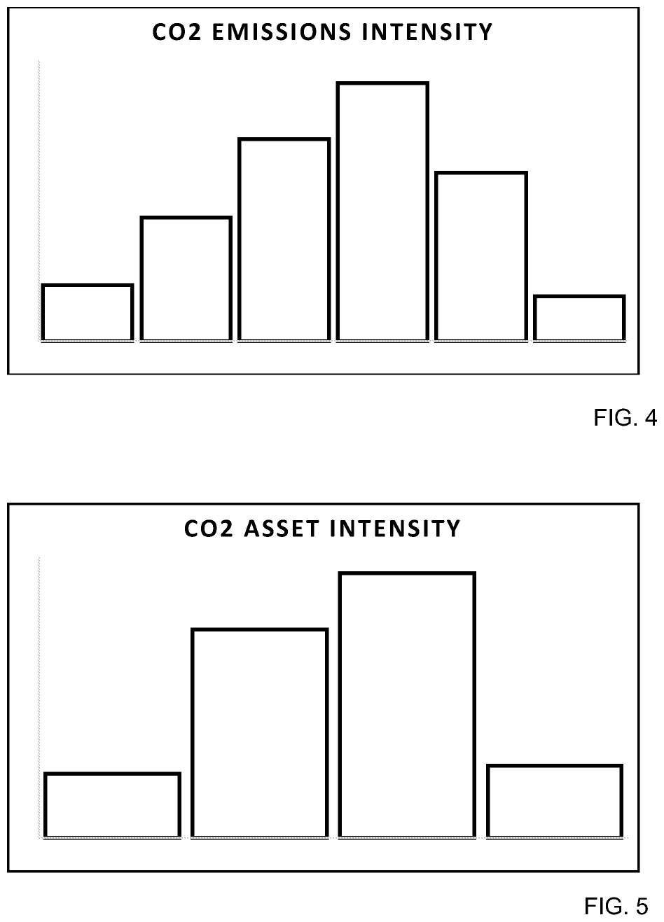

As discussed above, in this example, the greenhouse gas emissions data stored in the GHG emissions database 400 identifies one or more of the volume and/or mass of the carbon dioxide, methane, nitrous oxide, fluorocarbons, sulfur dioxide, and/or volatile organic compounds produced per unit volume of fuel consumed by the associated motor vehicle(s), indexed by the foregoing article attributes of the associated motor vehicle(s). Therefore, as shown in FIG. 4, the greenhouse gas emissions models may include, for example, a histogram identifying the distribution of the emissions intensity values of one or more of the foregoing greenhouse gases emitted for the motor vehicles referenced in the asset database 300.

Further, as discussed above, in this example, the attribute database 214 (and the asset database 300) includes the loan amounts associated with the motor vehicles financed by the financial institution. The GHG emissions modeller 220 may translate the retrieved attribute sets by also generating asset intensity values from the located greenhouse gas emissions data and the loan amounts and incorporating the generated asset intensity values into the greenhouse gas emissions models. The GHG emissions modeller 220 may then transmit the greenhouse gas emissions models to the operator terminal 150 for rendering on the display device thereof.

Each asset intensity value incorporated into the greenhouse gas emissions models may identify the volume and/or mass of greenhouse gases emitted per unit of the associated loan amount. Therefore, as shown in FIG. 5, the greenhouse gas emissions models may include, for example, a histogram identifying the distribution of the asset intensity values for one or more of the foregoing greenhouse gases emitted for the motor vehicles referenced in the asset database 300.

1. A greenhouse gas emissions model generating system comprising:
an identifier decoder configured to receive indefinite article identifiers and to translate the received indefinite article identifiers into attribute sets, wherein each said indefinite article identifier non-uniquely identifies an article of manufacture, and wherein each said attribute set includes article attributes associated with the respective article of manufacture;
an emissions database comprising a plurality of emissions records each including greenhouse gas emissions data indexed by the article attributes; and
an emissions modeller configured to receive the attribute sets and to translate each said received attribute set into a greenhouse gas emissions model,
wherein the emissions modeller is configured to translate each said received attribute set by locating a respective matching emissions record in the emissions database, and
wherein amongst the plurality of emissions records the article attributes of each said received attribute set most closely match the article attributes of the respective matching emissions record.

2. The system according to claim 1, wherein each said indefinite article identifier identifies a group of articles, wherein the group of articles includes the respective article of manufacture and each said attribute set includes the article attributes common to the respective group of articles.

3. The system according to claim 2, wherein each said article of manufacture is uniquely identified by a respective unique sequence of characters, and each said indefinite article identifier includes a sub-set of the respective unique sequence of characters, the sub-set including fewer of the characters than the respective unique sequence of characters.

4. The system according to claim 2, further including an asset database and an attribute database,
wherein the asset database includes a plurality of asset records each associated with one of the articles of manufacture and including the indefinite article identifier of the one article of manufacture,
wherein the attribute database includes a plurality of attribute records each associated with one of the articles of manufacture and including the attribute set of the one article of manufacture, and
wherein the identifier decoder is configured to retrieve said indefinite article identifiers from the asset database each via one of a plurality of threads, and to translate the received indefinite article identifiers by at least saving the attribute sets in the attribute database each via the respective one thread.

5. The system according to claim 4, wherein:
the articles of manufacture include motor vehicles; and
the emissions modeller configured to translate the attribute sets by at least generating emissions intensity values and incorporating the emissions intensity values into the greenhouse gas emissions models, wherein each said emissions intensity value identifies a volume of greenhouse gas emitted per unit of distance travelled for the respective group of the motor vehicles.

6. The system according to claim 5, wherein each said asset record of the asset database further includes a monetary amount associated with the one article of manufacture; and
wherein the emissions modeller is configured to retrieve the monetary amounts from the asset database, and
the emissions modeller is configured to translate the attribute sets by at least generating asset intensity values and incorporating the asset intensity values into the greenhouse gas emissions models, wherein each said asset intensity value identifies a volume of greenhouse gas emitted per unit of the monetary amount.

7. The system according to claim 1, wherein the emissions modeller is configured to use a fuzzy name matching algorithm to locate each respective matching emissions record in the emissions database.

8. A method of generating greenhouse gas emissions models comprising:
an identifier decoder receiving indefinite article identifiers, wherein each said indefinite article identifier non-uniquely identifies an article of manufacture;
the identifier decoder translating the received indefinite article identifiers into attribute sets, wherein each said attribute set includes article attributes associated with the respective article of manufacture;
an emissions modeller receiving the attribute sets; and
the emissions modeller translating each said received attribute set into a greenhouse gas emissions model via an emissions database,
wherein the emissions database comprises a plurality of emissions records each including greenhouse gas emissions data indexed by the article attributes,
wherein the translating each said received attribute set comprises the emissions modeller locating a respective matching emissions record in the emissions database, and
wherein amongst the plurality of emissions records the article attributes of each said received attribute set most closely match the article attributes of the respective matching emissions record.

9. The method according to claim 8, wherein each said indefinite article identifier identifies a group of articles, wherein the group of articles includes the respective article of manufacture and each said attribute set includes the article attributes common to the respective group of articles.

10. The method according to claim 9, wherein each said article of manufacture is uniquely identified by a respective unique sequence of characters, and each said indefinite article identifier includes a sub-set of the respective unique sequence of characters, the sub-set including fewer of the characters than the respective unique sequence of characters.

11. The method according to claim 9, wherein the receiving indefinite article identifiers comprises the identifier decoder retrieving said indefinite article identifiers from an asset database each via one of a plurality of threads, and the translating the received indefinite article identifiers comprises the identifier decoder saving the attribute sets in an attribute database each via the respective one thread, wherein the asset database includes a plurality of asset records each associated with one of the articles of manufacture and including the indefinite article identifier of the one article of manufacture, and wherein the attribute database includes a plurality of attribute records each associated with one of the articles of manufacture and including the attribute set of the one article of manufacture.

12. The method according to claim 11, wherein:
the articles of manufacture include motor vehicles; and
the translating the attribute sets comprises the emissions modeller generating emissions intensity values and incorporating the emissions intensity values into the greenhouse gas emissions models, wherein each said emissions intensity value identifies a volume of greenhouse gas emitted per unit of distance travelled for the respective group of the motor vehicles.

13. The method according to claim 12, wherein:
the receiving indefinite article identifiers comprises the identifier decoder receiving the set of indefinite article identifiers from the asset database, wherein each said asset record of the asset database further includes a monetary loan amount associated with the one article of manufacture; and
the translating the attribute sets comprises the emissions modeller generating asset intensity values and incorporating the asset intensity values into the greenhouse gas emissions models, wherein each said asset intensity value identifies a volume of greenhouse gas emitted per unit of the loan amount.

14. The method according to claim 8, wherein the locating a respective matching emissions record comprises the emissions modeller using a fuzzy name matching algorithm to locate each respective matching emissions record.

15. A non-transient computer-readable medium carrying processing instructions which, when executed by a computer, cause the computer to implement a method comprising:
receiving indefinite article identifiers, wherein each said indefinite article identifier non-uniquely identifies an article of manufacture;
translating the received indefinite article identifiers into attribute sets, wherein each said attribute set includes article attributes associated with the respective article of manufacture; and
translating each said attribute set into a greenhouse gas emissions model via an emissions database, wherein the emissions database comprises a plurality of emissions records each including greenhouse gas emissions data indexed by the article attributes,
wherein the translating each said attribute set comprises the computer locating a respective matching emissions record in the emissions database, and
wherein amongst the plurality of emissions records the article attributes of each said attribute set most closely match the article attributes of the respective matching emissions record.

16. The computer-readable medium according to claim 15, wherein each said indefinite article identifier identifies a group of articles, wherein the group of articles includes the respective article of manufacture and each said attribute set includes the article attributes common to the respective group of articles.

17. The computer-readable medium according to claim 16, wherein each said article of manufacture is uniquely identified by a respective unique sequence of characters, and each said indefinite article identifier includes a sub-set of the respective unique sequence of characters, the sub-set including fewer of the characters than the respective unique sequence of characters.

18. The computer-readable medium according to claim 16, wherein the processing instructions cause the computer to retrieve said indefinite article identifiers from an asset database each via one of a plurality of threads, and to translate the received indefinite article identifiers by at least saving the attribute sets in an attribute database each via the respective one thread, wherein the asset database includes a plurality of asset records each associated with one of the articles of manufacture and including the indefinite article identifier of the one article of manufacture, and wherein the attribute database includes a plurality of attribute records each associated with one of the articles of manufacture and including the attribute set of the one article of manufacture.

19. The computer-readable medium according to claim 18, wherein:
the articles of manufacture include motor vehicles; and
the processing instructions cause the computer to generate emissions intensity values and incorporate the emissions intensity values into the greenhouse gas emissions models, wherein each said emissions intensity value identifies a volume of greenhouse gas emitted per unit of distance travelled for the respective group of the motor vehicles.

20. The computer-readable medium according to claim 19, wherein:
the processing instructions cause the computer to receive the set of indefinite article identifiers from the asset database, generate asset intensity values and incorporate the asset intensity values into the greenhouse gas emissions models,
wherein each said asset record of the asset database further includes a monetary loan amount associated with the one article of manufacture, and each said asset intensity value identifies a volume of greenhouse gas emitted per unit of the loan amount.
